(19) United States
(12) Patent Application Publication
(10) Pub. No.: US 2010/0332137 A1
(43) Pub. Date: Dec. 30, 2010

(54) CASING DETECTION

(75) Inventors: Michael M. Meadows, Cypress, TX (US); Allen Richard Young, Houston, TX (US); Jameel Khan, Fort Worth, TX (US)

Correspondence Address: WINSTEAD PC, P.O. BOX 50784, DALLAS, TX, 75201, US

(73) Assignee: Multi-Shot, LLC., Conroe, TX (US)

(21) Appl. No.: 12/439,759

(22) PCT Filed: Sep. 6, 2007
(86) PCT No.: PCT/US07/77786

§ 371 Date: Aug. 12, 2010

Related U.S. Application Data
(60) Provisional application No. 60/842,702, filed on Sep. 6, 2006.

(51) Int. Cl. G01V 3/08; G06F 19/00

(52) U.S. Cl. 702/6; 324/326

(57) ABSTRACT

A system and method for detecting casing is provided. In one example, a method for detecting drill casing in a downhole environment includes the steps of generating a plurality of plots of a magnetic field vector (MIN) at a series of depths; and monitoring the plots to detect proximity to the well casing.

### RELATED APPLICATIONS

This application claims the benefit of U.S. Provisional Patent Application No. 60/842,702 filed Sep. 6, 2006.

### FIELD OF THE INVENTION

This invention relates in general to oilfield drilling, and, more particularly, to detecting existing well casing.

### BACKGROUND

In the context of oil and gas fields, infill development involves the redevelopment of an existing oil and gas field. Infill drilling is drilling that occurs within the boundaries of an existing developed gas or oil field. During infill development, there is a possibility of accidentally drilling into existing well casing. In addition, new wells may be connected into or designed around existing oilfield infrastructure, e.g., sidetracking operations. In these two cases, it is desirable to be able to locate existing well casing.

Therefore, it is a desire to provide a system or method for avoiding accidental drilling into an existing well casing or to facilitate detecting existing well casing for sidetracking operations.

### SUMMARY OF THE INVENTION

In view of the foregoing and other considerations, the present invention relates to detecting well casing in a downhole environment.

In one example, a method for detecting drill casing in a downhole environment is provided. The method includes the steps of generating a plurality of plots of a magnetic field vector (MFV) at a series of depths; and monitoring the plots to detect proximity to the well casing.

In another example, a system for detecting a drilling casing is provided. The system includes a tool to detect a magnetic field, wherein the tool may be rotated about a longitudinal tool axis to generate a series of magnetic field measurements. The system also includes a processor to generate a series of plots of a magnetic field vector (MFV) based on the magnetic field measurements, wherein each plot comprises a shape that is based on spatial proximity of the tool to a magnetic source.

The foregoing has outlined the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is an example of the system for detecting well casing.

FIG. 2 is a partial cross section of an example of a sensor package used in the system of FIG. 1.

FIGS. 3A and 3B are views of the 3-dimensional polar plot of magnetic field vector (MFV).

FIG. 4 is a diagram illustrating the progressive change in the plot of MFV as the sensor package approaches a well casing.

FIG. 5 is a comparison of two plots of MFV from FIG. 4.

### DETAILED DESCRIPTION

Refer now to the drawings wherein depicted elements are not necessarily shown to scale and wherein like or similar elements are designated by the same reference numeral through the several views.

As used herein, the terms “up” and “down”; “upper” and “lower”; “uphole” and “downhole” and other like terms indicating relative positions to a given point or element are utilized to more clearly describe some elements of the embodiments of the invention. Commonly, these terms relate to a reference point as the surface from which drilling operations are initiated as being the top point and the total depth of the well being the lowest point.

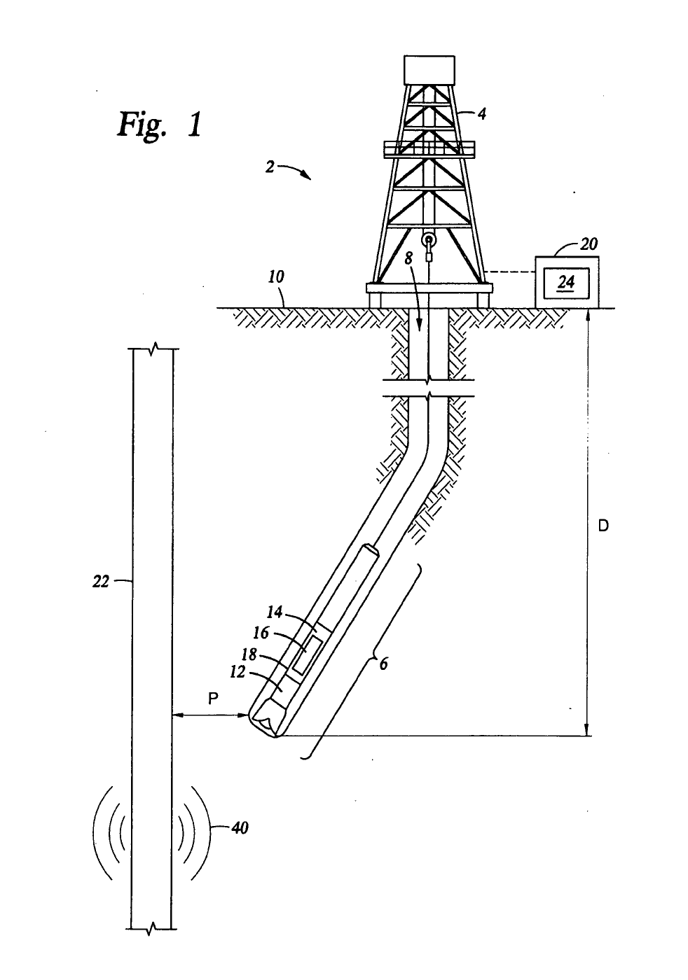

FIG. 1 shows a partial cross-section of an example of the system to locate existing well casing, shown generally by 2. Drilling rig 4 suspends or positions drillstring 6 within borehole 8 in rock formation 10. Drillstring 6 includes drill bit 12 and tool 14. Tool 14 may be a measurement-while-drilling (MWD) device, logging-while-drilling (LWD) device, or similar tool for conducting measurements of the downhole environment. Tool 14 may be a angle/azimuth tool or a fully steerable tool, for example. Tool 14 includes instrument package or steering unit 16 housed within drill collar 18 of tool 14. Surface device 20 may transmit or receive data from tool 14 via wired (e.g., via drillstring 6), wireless devices (e.g., transceivers or similar devices) or other methods of telemetry (e.g., mud pulses). Surface device 20 may include processor 21 to store and process data. Rock formation 10 is the site of infill development and includes existing well casing 22. Tool 14 is shown positioned downhole at a depth D from the surface and at a distance P from well casing 22. System 2 permits the detection of well casing 22 so that casing 22 may be avoided or intersected, depending on the desired operation.

Existing well casing 22 is typically made from steel or similar ferrous material and represents a relatively low impedance path to magnetic fields. Accordingly, there may be direction and magnitude of magnetic fields near casing 22. The total magnetic field (TMF), indicated generally at 40, may vary based on proximity to casing 22.

The value for TMF may be expressed as shown below in Equation 1:

TMF=(Mₓ²+M_{y}²+M_{z}²)^{1/2} (1)

In Equation 2, Mₓ, M_{y} and M_{z} are the orthogonal magnetic field values sensed by the magnetometers 24.

Detection of casing 22 based on the distortion of static fields using static measurements, however, may prove difficult. System 2 measures TMF 40 to detect or locate casing 22 by taking advantage of the drilling process itself.

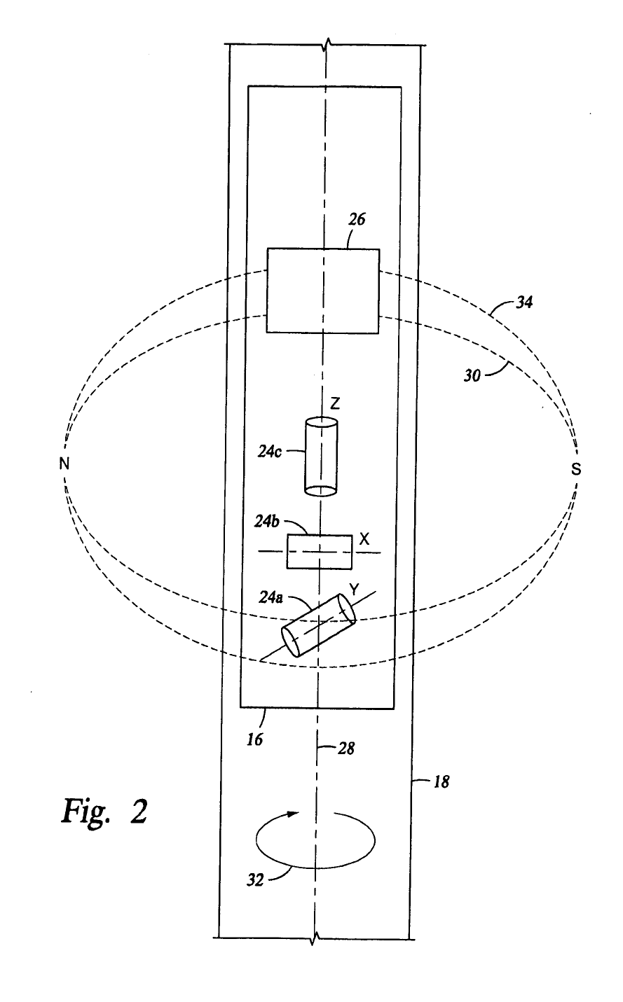

FIG. 2 shows a partial cross-section side view of steering unit 16. During rotary drilling, steering unit 16 detects the rotation of drillstring 6, indicated as direction 32. When pipe rotation ceases, steering unit 16 may be used to perform a survey of the borehole 8 within rock formation 10. Steering unit 16 includes three orthogonal magnetometers 24 that are used to conduct the survey. Each sensor 24 is substantially normal to tool axis 28 and has an axis 30 that is substantially aligned along the x-axis, y-axis or z-axis. Steering unit 16 or tool 14 may include processor 26 to store and process data. During drilling, the x-axis and y-axis magnetometers 24a and 24b are presented with a varying magnetic field vector for magnetic field 34. As each axis 30 of the magnetometers 24 alternatively aligns with magnetic north, the field strength that the magnetometer 24 receives is at a relative maximum. Similarly, as a given axis 30 becomes oriented 90° to magnetic north, the measured field strength is at a relative minimum.

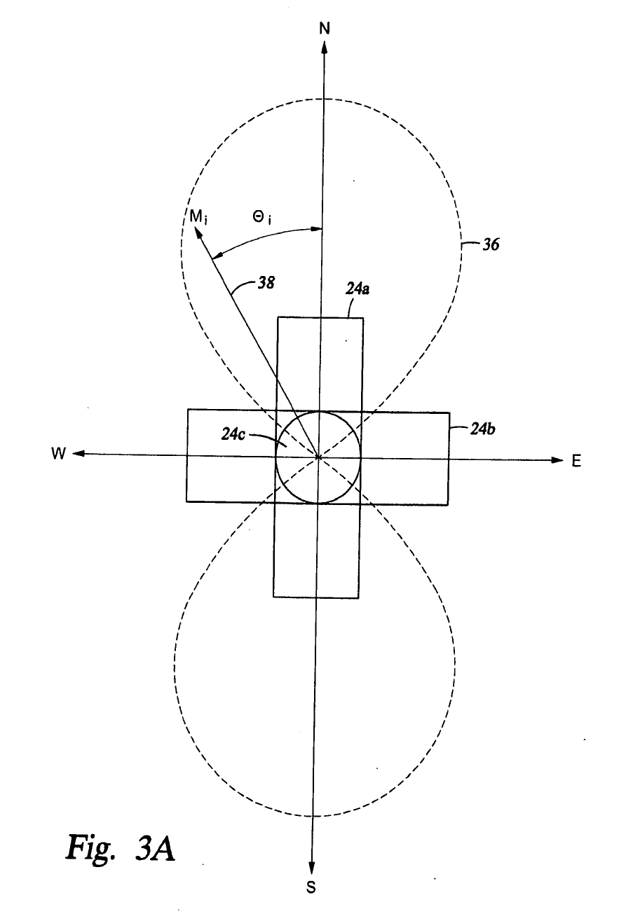

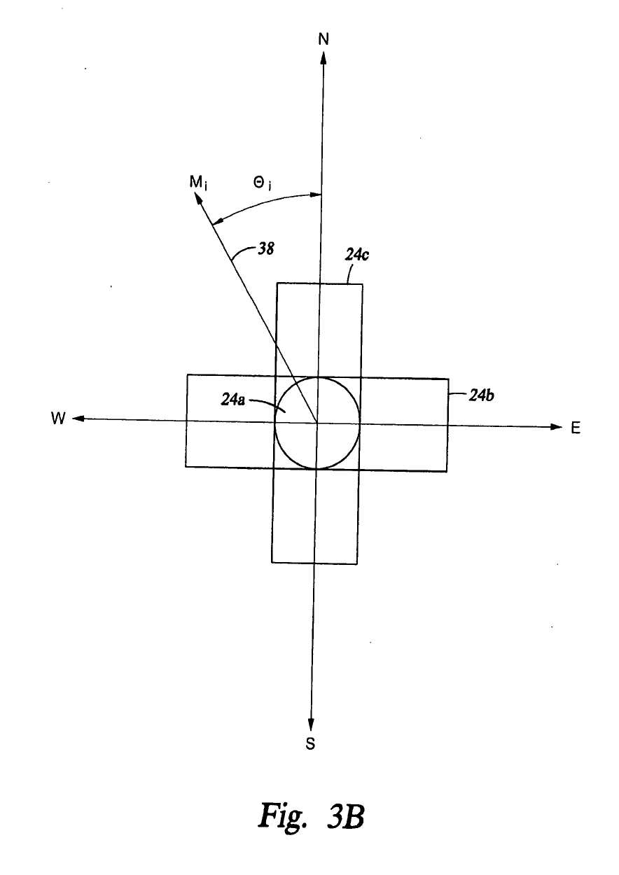

Because magnetometers 24a and 24b, which are positioned normal to drill collar 18 rotating about tool axis 28 as it rotates in direction 32, pass through a maximum and minimum magnetic field strength as described, the field strength may be mapped at other angular orientations as well. FIG. 3A shows an example of a plot 36 of the polar magnetic vectors of earth field strength in formation 10 superimposed on a top-down view of magnetometers 24, e.g., showing the x-axis and y-axis. FIG. 3B shows a sketch of plot 36 showing the z-axis contribution measured from magnetometer 24c as zero. It will be understood by those of ordinary skill in the art that this contribution is not necessarily always zero and may be distorted based on nearby ferrous objects and by the presence of magnetic dip which may give a natural, non-zero, z-axis component. Accordingly, polar plot 36 is a 3-dimensional plot representing an accumulation of vectors 38 with angle θᵢ and field strength Mᵢ. Plot 36 may be determined from an average of multiple samples for vectors 38 over time. Plot 36 may be calculated by surface processor 21 or tool processor 26.

Polar plot 36 may be expressed as a magnetic field vector (MFV), which describes polar plot 36 in matrix form as shown below in Equation 2:

$$\underline{MFV} = [ \begin{matrix}{Θ}_{1} & {M}_{1} \\ {Θ}_{2} & {M}_{2} \\ ⋯ & ⋯ \\ {Θ}_{i} & {M}_{i} \\ ⋯ & ⋯ \\ {Θ}_{f} & {M}_{f}\end{matrix} ] \qquad ( 2 )$$

In Equation 2, Θᵢ is the apparent field direction; Θ_{f} is the maximum angle (e.g., 360°) of angular displacement during rotation; and M_{f} is the average field at the maximum angle.

The value |MFV| is related to TMF, and may be expressed as shown below in Equation 3:

$$\vert MFV \vert = \sqrt{{\sum }_{i}^{f} {M}_{i}} . \qquad ( 3 )$$

TMF may be used as a factor to indicate close proximity to existing well casing 22. Similarly, the value for MFV may be affected by the presence of ferrous materials such as those found in casing 22 or the magnetic anomalies in casing 22 caused, for example, by previous pipe inspections. Through the use of metrics related to the shape of the MFV at any given drilling depth D, system 2 allows a user to identify, in a progressive manner, relative proximity P to a magnetic anomaly such as casing 22.

Referring FIGS. 3A and 3B, plot 36 corresponds to an MFV that is not subject to any distortion, such as that caused by nearby ferrous objects such as casing 22. Accordingly, plot 36 may correspond to the MFV at a depth D and distance P relatively distant from casing 22, e.g., at spudding.

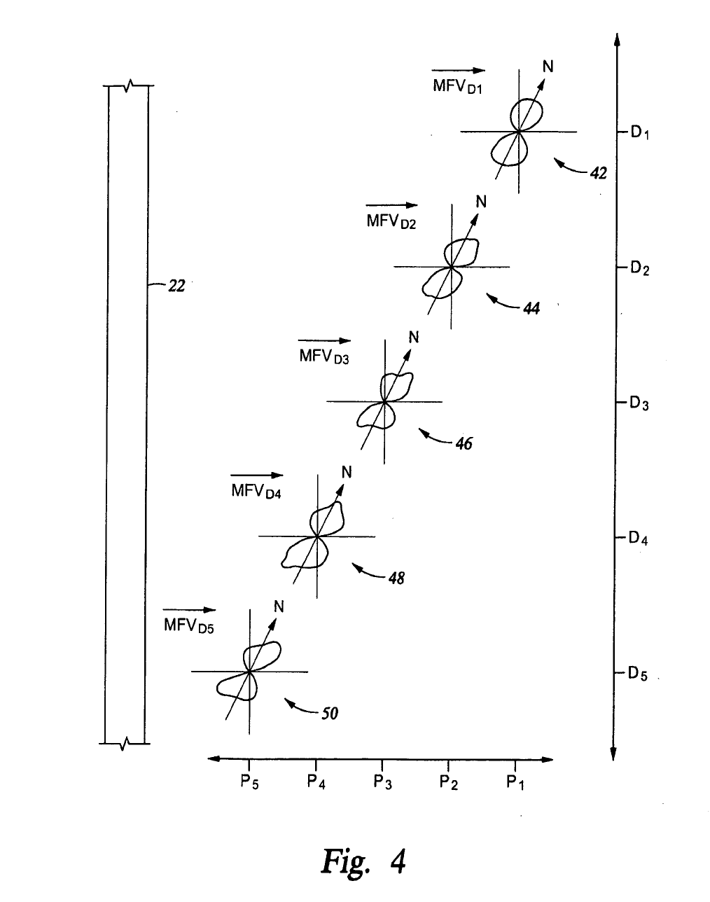

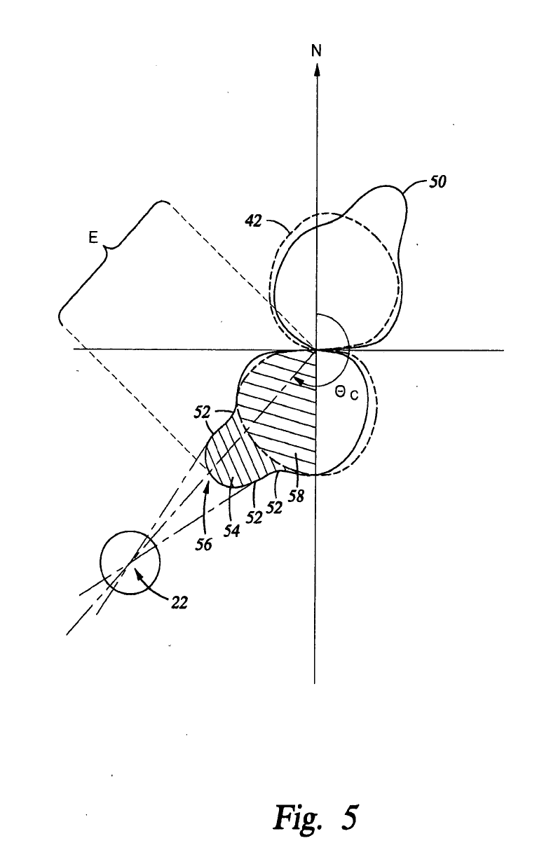

FIGS. 4 and 5 show an example of how the shape of the polar plot of MFV changes as tool 14 approaches casing 22. With further reference to FIG. 1, as distance P decreases, the plot for MFV will manifest changes that a user may monitor to detect and locate casing 22. Referring to FIG. 4, plot 42 corresponds to the polar plot of MFV at depth D1 and distance P1 from casing 22. Plot 44 corresponds to the polar plot of MFV at depth D2 and distance P2 from casing 22, where depth D2 is greater than D1, and distance P2 is less than P1. Similarly, plots 46, 48 and 50 correspond to polar plots of MFV as tool 14 is positioned downhole at greater depths D and closer proximity P to casing 22, respectively.

Initially, when tool 14 is at depth D1 and distance P1 from casing 22, casing 22 does not exert any magnetic field distortion upon the MFV generated by tool 14 (e.g., plot 42 is similar to plot 36 of FIG. 3A). As depth D1 increases to D5, tool 14 approaches casing 22, and therefore, the distance P1 decreases to P5. As P1 decreases to P5, the magnetic field distortion caused by casing 22 increases. This distortion results in a change of shape of the plot of MFV.

FIG. 5 shows the plot 50 superimposed upon plot 42 to illustrate the difference in shape between plot 42 at depth D1 and plot 50 at depth D5. In contrast to plot 42, plot 50 includes additional quadrant area 54 that distends outwards from quadrant area 58 (which corresponds to the initial area for that quadrant in plot 42). The shape of additional quadrant area 54 is substantially defined by inflection points 52. The shape of additional quadrant area 54 indicates the relative positioning and proximity of casing 22 because quadrant area 54 is caused by magnetic field distortion generated by casing 22. For example, additional quadrant area 54 is most distorted or extended at point 56 at an angle θc, e.g., distance E is greatest at point 56. Note that this distance E corresponds to the largest vector 38 (shown in FIG. 3) and therefore corresponds to direction θc in which the magnetic distortion caused by casing 22 has substantially the greatest effect on the plot of MFV. Accordingly, the shape and size of additional quadrant area 54 indicates the probable location of casing 22. In this manner, a user may monitor the transition of plot 42 to 50 to observe the emergence of additional quadrant area 54 to determine the existence and location of casing 22. Guidelines may be developed for selected plot shapes that correspond to casing proximity. A user, tool 14 or surface device 20 may compare the real-time plots of MFV to these guidelines to determine whether a well casing is nearby. Tool 14 may transmit an alert or signal to a user or surface device 20 upon determining a correspondence with a stored guideline that indicates the likelihood of a nearby well casing 22.

For the purposes of clarity, the contribution along the z-axis for the MFV plots are not shown in the examples discussed above in connection with FIGS. 4 and 5. Given that the plots for MFV may exhibit reflection symmetry, a user may need to consult the contribution along the z-axis, in addition to that along the x-axis and y-axis to determine the correct direction in which casing 22 is positioned relative to tool 14. For example, where drilling is not truly vertical, the z-axis contribution may change over time and may be non-zero. As another example, magnetic dip may need to be considered due to magnetic vector directions that are not parallel to the Earth's surface. The relationship between the x-axis and y-axis contributions are further changed as the sensor package 16 approaches a long narrow object such as casing 22. In addition, the TMF or vector sum of the x-, y- and z-axis may be altered, increasing or decreasing depending upon the polar relationships among tool 14, well casing 22 and magnetic north. The shape of the MFV plot will distort and change in direct relation to the above factors.

Typically, time is a premium during drilling operations. As a result, a slow, incremental approach to acquiring MFV data is generally not feasible. In survey-only operation, a mode often used in operating directional tools in a substantially vertical well, the magnetic sensors are normally not queried at all during drilling. In contrast, system 2 collects data from magnetic sensors 24 during times when magnetic sensors are typically dormant and takes advantage of the rotation that occurs from the drilling process. For example during the time required to penetrate the depth of one drill pipe joint. In addition, MFV data may be collected over a shorter depth interval at any time by stopping drilling and pulling bit 12 off the bottom. As a result, the disclosed system and method provide an economical process for locating casing, whether for avoidance or planned sidetracking.

The speed with which magnetic field measurements may be taken may be based on the rotation rate of drillstring 6, and the sample rate of magnetometers 24, among other factors. For example, if magnetometer 24 is rotated at about 1 RPS, then a rate of 1 sample per 1/120 second for each axis will be required to map the fields to an angular resolution of about 3°. The sample rate would be 120 samples/second for each sensor 24a and 24b (x-axis and y-axis) and the z-axis measurement would simply give the inclination of the x and y field plane. The rate of 120 samples/second corresponds to 1 “averaged” sample from each sensor 24a and 24b about once every 8.33 milliseconds. The components of tool 14 may limit the number of raw samples that can be obtained during this time, e.g., the base raw data rate of the analog-to-digital converters (ADCs) of magnetometer 24. The repetitive nature of drilling rotation allows the averaging of several MFV data sets to provide an MFV vector of relatively high accuracy for a period of several minutes.

In a further example, a magnetometer sensor package may have a sample rate shown in Equation 4 below:

3 sensors×512 samples/0.403 seconds=3811 samples/second (4)

This sample rate, divided primarily between magnetometer 24a (y-axis) and magnetometer 24b (x-axis), would provide a rate of 1906 samples/second/sensor or 1906 samples/360 rotations. This would provide a capability of 1 sample per 0.2°, which is greater than the selected resolution discussed above. Thus, a 16 sample average would provide an angular resolution of about 3° at a nominal RPM of 60.

From the foregoing detailed description of specific embodiments of the invention, it should be apparent that a system for casing detection that is novel has been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

What is claimed is:

1. A method for detecting drill casing in a downhole environment, comprising:
generating a plurality of plots of a magnetic field vector (MFV) at a series of depths; and
monitoring the plots to detect proximity to the well casing.

2. The method of claim 1, further comprising the step of positioning a tool into the downhole environment to detect magnetic fields at the series of depths, wherein the tool comprises a longitudinal tool axis and three orthogonal magnetometers, aligned normal to the tool axis.

3. The method of claim 2, further comprising the step of rotating the tool through a plurality of revolutions as the tool detects the magnetic fields.

4. The method of claim 3, further comprising the step of rotating the tool and detecting magnetic fields as the tool is positioned downhole through the series of depths to generate data for the plots.

5. The method of claim 4, wherein each plot comprises a shape based on the detected magnetic fields and further comprising the step of monitoring the shapes of the plots to detect anomalies associated with the presence of the well casing.

6. The method of claim 5, further comprising the step of monitoring inflections in the shapes of the plots.

7. The method of claim 6, further comprising the step of monitoring distortions in the shapes of the plots.

8. The method of claim 7, defining a guideline of shapes of the plots that indicates a likelihood of proximity of the tool to the well casing.

9. The method of claim 8, further comprising the step of comparing the plots to the guideline.

10. The method of claim 9, further comprising the step of transmitting a signal indicating proximity to the well casing to a surface device.

11. A system for detecting a drilling casing, comprising
a tool to detect a magnetic field, wherein the tool may be rotated about a longitudinal tool axis to generate a series of magnetic field measurements;
a processor to generate a series of plots of a magnetic field vector (MFV) based on the magnetic field measurements, wherein each plot comprises a shape that is based on spatial proximity of the tool to a magnetic source.

12. The system of claim 11, wherein the tool comprises three orthogonal magnetometers, aligned normal to the tool axis.

13. The system of claim 11, wherein the plot of the MFV comprises an angular resolution of at least about 3 degrees.

14. The system of claim 11, wherein a surface device comprises the processor.

15. The system of claim 11, wherein the tool comprises the processor.

16. The system of claim 11, wherein the tool is angle/azimuth tool.

17. The system of claim 11, wherein the tool is a fully steerable tool.
